(19) United States
(12) Patent Application Publication
(10) Pub. No.: US 2007/0142987 A1
(43) Pub. Date: Jun. 21, 2007

(54) Vehicle integrated control system

(75) Inventors: Hideki Takamatsu, Aichi-ken (JP); Takaaki Tokura, Aichi-ken (JP)

Correspondence Address: OLIFF & BERRIDGE, PLC, P.O. BOX 19928, ALEXANDRIA, VA, 22320, US

(73) Assignee: TOYOTA JIDOSHA KABUSHIKI KAISHA, Toyota-shi, Aichi-ken (JP)

(21) Appl. No.: 10/582,274

(22) PCT Filed: Dec. 13, 2004
(86) PCT No.: PCT/JP04/18967

§ 371 Date: Jun. 9, 2006

(30) Foreign Application Priority Data
Dec. 26, 2003 (JP) 2003-432144

(51) Int. Cl. B62D 6/00

(52) U.S. Cl. 701/41

(57) ABSTRACT

An integrated control system includes a main control system (accelerator) controlling a driving system, a main control system (brake) controlling a brake system, and a main control system (steering) controlling a steering system, based on manipulation by a driver, as well as an adviser unit generating and providing information to be used at each main control system based on environmental information around a vehicle or information related to a driver. The advisor unit executes a program including the steps of: sensing a vehicle state, driver's manipulation, and environmental information; operating an expected value by the driver with regard to a driving force; performing distribution processing of a braking/driving torque; and operating a distribution ratio so as to carry out distribution.

### TECHNICAL FIELD

The present invention relates to a system controlling a plurality of actuators incorporated in a vehicle, and more particularly, a system controlling in an integrated manner a plurality of actuators with the possibility of mutual interference.

### BACKGROUND ART

There has been an increasing trend in recent years towards incorporating many types of motion control devices in the same vehicle to control the motion of the vehicle. The effect produced by each of the different types of motion control devices may not always emerge in a manner independent of each other at the vehicle. There is a possibility of mutual interference. It is therefore important to sufficiently organize the interaction and coordination between respective motion control devices in developing a vehicle that incorporates a plurality of types of motion control devices.

For example, when it is required to incorporate a plurality of types of motion control devices in one vehicle in the development stage of a vehicle, it is possible to develop respective motion control devices independently of each other, and then implement the interaction and coordination between respective motion control devices in a supplemental or additional manner.

In the case of developing a plurality of types of motion control devices in the aforesaid manner, organization of the interaction and coordination between respective motion control devices requires much time and effort.

With regards to the scheme of incorporating a plurality of types of motion control devices in a vehicle, there is known the scheme of sharing the same actuator among the motion control devices. This scheme involves the problem of how the contention among the plurality of motion control devices, when required to operate the same actuator at the same time, is to be resolved.

In the above-described case where the interaction and coordination among a plurality of motion control devices are to be organized in a supplemental or additional manner after the motion control devices are developed independently of each other, it is difficult to solve the problem set forth above proficiently. In practice, the problem may be accommodated only by selecting an appropriate one of the plurality of motion control devices with precedence over the others, and dedicate the actuator to the selected motion control device alone.

An approach related to the problem set forth above in a vehicle incorporating a plurality of actuators to drive a vehicle in the desired behavior is disclosed in the following publications.

Japanese Patent Laying-Open No. 5-85228 (Document 1) discloses an electronic control system of a vehicle that can reduce the time required for development, and that can improve the reliability, usability, and maintenance feasibility of the vehicle. This electronic control system for a vehicle includes elements coacting for carrying out control tasks with reference to engine power, drive power and braking operation, and elements for coordinating the coaction of the elements to effect a control of operating performance of the motor vehicle in correspondence to a request of the driver. Respective elements are arranged in the form of a plurality of hierarchical levels. At least one of the coordinating elements of the hierarchical level is adapted for acting on the element of the next hierarchical level when translating the request of the driver into a corresponding operating performance of the motor vehicle thereby acting on a pre-given subordinate system of the driver-vehicle system while providing the performance required from the hierarchical level for this subordinate system.

By organizing the entire system in a hierarchy configuration in accordance with this electronic control system for a vehicle, an instruction can be conveyed only in the direction from an upper level to a lower level. The instruction to execute the driver's request is transmitted in this direction. Accordingly, a comprehensible structure of elements independent of each other is achieved. The linkage of individual systems can be reduced to a considerable level. The independency of respective elements allows the individual elements to be developed concurrently at the same time. Therefore, each element can be developed in accordance with a predetermined object. Only a few interfaces with respect to the higher hierarchical level and a small number of interfaces for the lower hierarchical level have to be taken into account. Accordingly, optimization of the totality of the driver and the vehicle electronic control system with respect to energy consumption, environmental compatibility, safety and comfort can be achieved. As a result, a vehicle electronic control system can be provided, allowing reduction in the development time, and improvement in reliability, usability, and maintenance feasibility of a vehicle.

Japanese Patent Laying-Open No. 2003-191774 (Document 2) discloses a integrated type vehicle motion control device adapting in a hierarchy manner a software configuration for a device that controls a plurality of actuators in an integrated manner to execute motion control of a plurality of different types in a vehicle, whereby the hierarchy structure is optimized from the standpoint of practical usage. This integrated vehicle motion control device controls a plurality of actuators in an integrated manner through a computer based on information related to driving a vehicle by a driver to execute a plurality of types of vehicle motion control for the vehicle. At least the software configuration among the hardware configuration and software configuration includes a plurality of elements organized in hierarchy in a direction from the driver towards the plurality of actuators. The plurality of elements include: (a) a control unit determining the target vehicle state quantity based on the driving-related information at the higher level; and (b) an execution unit receiving the determined target vehicle state quantity as an instruction from the control unit to execute the received instruction via at least one of the plurality of actuators at the lower level. The control unit includes an upper level control unit and a lower level control unit, each issuing an instruction to control the plurality of actuators in an integrated manner. The upper level control unit determines a first target vehicle state quantity based on the driving-related information without taking into account the dynamic behavior of the vehicle, and supplies the determined first target vehicle state quantity to the lower level control unit. The lower level control unit determines the second target vehicle state quantity based on the first target vehicle state quantity received from the upper level control unit, taking into account the dynamic behavior of the vehicle, and supplies the determined second target vehicle state quantity to the execution unit. Each of the upper level control unit, the lower level control unit, and the execution unit causes the computer to execute a plurality of modules independent of each other on the software configuration to realize unique functions thereof.

In accordance with this integrated type vehicle motion control device, at least the software configuration among the hardware configuration and software configuration is organized in a hierarchy structure so as to include: (a) a control unit determining a target vehicle state quantity based on driving-related information at the higher level in the direction from the driver to the plurality of actuators; and (b) an execution unit receiving the determined target vehicle state quantity as an instruction from the control unit to execute the received instruction via at least one of the plurality of actuators at the lower level. In other words, at least the software configuration is organized in hierarchal levels such that the control unit and the execution unit are separated from each other in this vehicle motion control device. Since the control unit and the execution unit are independent of each other from the software configuration perspective, respective stages of development, designing, design modification, debugging and the like can be effected without influencing the other. Respective stages can be carried out concurrently with each other. As a result, the period of the working stage required for the entire software configuration can be readily shortened by the integrated vehicle motion control device.

A technique related to mitigation of shock due to gear shift in an automatic transmission is disclosed in the following publication.

Japanese Patent Laying-Open No. 8-85373 (Document 3) discloses a brake control device for a vehicle with an automatic transmission mitigating shock due to gear shift without particular modification of a hydraulic control system of the automatic transmission. The brake control device for a vehicle with an automatic transmission includes an automatic transmission, and means capable of applying a braking force to driving wheels independently of a brake manipulation by a driver. The brake control device for a vehicle with an automatic transmission further includes means for detecting a prescribed time relevant to gear shift of the automatic transmission, means for detecting a type of gear shift, means for detecting requested engine output, and means for setting a braking force in gear shift so as to allow control of a manner of variation of acceleration of a vehicle in gear shift to a desired manner in accordance with the type of gear shift and the requested engine output. The brake control device for a vehicle with an automatic transmission thus applies a braking force in gear shift from a prescribed time.

According to the brake control device for a vehicle with an automatic transmission, shock due to gear shift is mitigated by applying a braking force to the driving wheels when the automatic transmission is in the course of gear shift. Here, the braking force does not necessarily have to be associated with control for reduction of an engine torque, and the braking force is set in accordance with the type of gear shift and the requested engine output, in order to attain a desired manner of variation of acceleration of the vehicle. Accordingly, shock due to gear shift can always be mitigated without particular modification of the hydraulic control system of the automatic transmission or without such restriction as inability to do so at the time of cold start, for example.

The control devices disclosed in Documents 1 and 2, however, do not show specific contents related to control of coordination of actuators involved in vehicle motion such as driving and braking.

In addition, unlike the hierarchical control configuration (Document 1) or the hierarchy achieved by separating software configuration into at least the control unit and the execution unit (Document 2), the brake control device for a vehicle with an automatic transmission disclosed in Document 3 is implemented merely by adding brake control in controlling transmission, without being directed to integrated control of a vehicle. That is, Document 3 does not relate to integrated or hierarchical control of the vehicle.

### DISCLOSURE OF THE INVENTION

The present invention was made to solve the above-described problems. An object of the present invention is to provide a vehicle integrated control system capable of faithfully reflecting an intention of a driver on a behavior of the vehicle. A specific system configuration of the vehicle integrated control system is provided.

According to the present invention, a vehicle integrated control system includes a plurality of control units controlling a running state of a vehicle based on a manipulation request, and a processing unit generating information to be used at the control units and providing the generated information to respective control units. The processing unit includes a calculation unit for calculating information related to a control target to manipulate an actuator set in correspondence with each control unit based on environmental information around the vehicle and the manipulation request, and calculating information for allotting a driving force and a braking force in the control unit, based on information related to the calculated control target.

According to the present invention, for example, the driving system control unit representing one example of the control unit generates a control target of the drive-system corresponding to a manipulation of an accelerator pedal using a driving basic driver model, so as to control a power train (engine, drive motor, transmission) serving as an actuator. The brake system control unit representing one example of the control unit generates a control target of the brake system corresponding to a manipulation of a brake pedal using a brake basic driver model, so as to control a brake device serving as an actuator. In these driving system control unit and brake system control unit that operate autonomously, a processing to allot a braking/driving force of a vehicle (hereinafter, it is assumed that to divide, to distribute, and to allot represent the same concept) is performed. In addition, the driving system control unit and the brake system control unit determine as to whether or not information input from the processing unit is to be reflected in the motion control of the vehicle, and to what extent, if to be reflected (arbitration). The driving system control unit and the brake system control unit also correct the control target, and transmit the information among respective control units. Since each control unit operates autonomously, the power train and the brake device are controlled eventually at respective control units based on the eventual driving target and braking target (control target) calculated from the driver's manipulation information, the information input from the processing unit, and information on distribution of the braking/driving force among the control units. Thus, the driving system control unit corresponding to a “running” operation that is the basic operation of the vehicle and the brake system control unit corresponding to a “stop” operation are provided operable in a manner independent of each other. Here, information for distributing the driving force and the braking force that corresponds to an environment around the vehicle and a manipulation by the driver is used in these control units in a parallel manner, so as to attain integrated control of the driving system control unit and the brake system control unit. As the driving force in the driving system control unit and the braking force in the brake system control unit are distributed by the processing unit, the driving force requested by the driver of the vehicle may be realized solely by controlling the driving system control unit, and the braking force requested by the driver of the vehicle may be realized solely by controlling the brake system control unit. In this case as well, the processing unit can control a driving force generation side and a driving force suppression side in an integrated manner, using various parameters. Accordingly, a vehicle integrated control system capable of faithfully reflecting an intention of the driver on a behavior of the vehicle can be provided. Specifically, a allotted amount of work of each force such as a driving force, a braking force, a steering force, and a sticking force (adhesion property of tires) in addition to the driving force and the braking force is determined through arbitration, such that forces (torque) acting between tires and a road surface are consistent with a target vehicle motion in order to optimize the vehicle motion. Then, each actuator is actuated. As the environmental information around the vehicle is used in calculating the allotted amount, the intention of the driver and the control target generated by the computer can be reflected further faithfully on the behavior of the vehicle.

Preferably, the calculation unit calculates the information with priority being placed on a time for attaining the control target.

According to the present invention, for example, when the driver suddenly presses down the accelerator pedal, the braking force by the brake system control unit is quickly decreased, a torque generated from the engine or a drive motor in the driving system control unit is rapidly increased, and the gear ratio is shifted down to a level allowing generation of a high torque. Under such integrated control, fuel efficiency may be lowered to a level outside an optimal fuel consumption range of the engine, or lowering of drivability may be caused due to excessive acceleration. In spite of such disadvantages, priority can be placed on a time for attaining the control target requested by the driver. On the other hand, when the driver suddenly presses down the brake pedal, the driving force by the driving system control unit is rapidly decreased, while the braking torque by a wheel brake in the brake system control unit is quickly increased. Under such integrated control, running energy may be converted to thermal energy at the wheel brake, and energy efficiency may be lowered. In spite of such disadvantages, priority can be placed on a time for attaining the control target requested by the driver. In the case of a vehicle equipped with a drive motor, regenerative braking may be achieved using that motor, instead of or in addition to the wheel brake.

Further preferably, the calculation unit calculates the information with priority being placed on drivability.

According to the present invention, when the driver presses down the brake pedal, for example, the transmission in the driving system control unit is shifted down, and the braking torque from the wheel brake in the brake system control unit is increased. When such integrated control is exerted, a control parameter of each actuator is calculated so that occurrence of shock due to gear shift is minimized. That is, priority is placed on drivability requested by the driver.

Further preferably, the calculation unit calculates the information with priority being placed on energy efficiency of the vehicle.

According to the present invention, when the driver presses down the brake pedal, for example, control is exerted such that power generation by a regenerative braking motor (drive motor) in the driving system control unit is maximized. Here, use of increase in the braking torque from the wheel brake in the brake system control unit in which energy cannot be recovered is avoided as much as possible, in a range satisfying the braking force requested by the driver. Under such integrated control, running energy that has conventionally been converted to thermal energy by the wheel brake in the brake system control unit can be recovered in the driving system control unit, thereby energy efficiency being improved.

Further preferably, the environmental information represents information on surroundings of the vehicle at present.

According to the present invention, optimal braking force and driving force are calculated respectively, based on information that a vehicle is currently running on a highway or on a national route. By controlling the driving system control unit and the brake system control unit in an integrated manner, the optimal braking force and driving force can be generated.

Further preferably, the environmental information represents information on surroundings of the vehicle in the future.

According to the present invention, such a situation that a vehicle is currently running before a corner, and the vehicle will decelerate for entering the corner in the near future and re-accelerate at the exit of the corner is sensed as the environmental information. An optimal braking/driving force is calculated in advance based on such information on the surroundings of the vehicle in the future and the driving system control unit and the brake system control unit are controlled in an integrated manner, so that the optimal braking/driving force can be generated.

Further preferably, the environmental information represents information on an acceleration/deceleration state of the vehicle.

According to the present invention, the driving system control unit and the brake system control unit can be controlled in an integrated manner, by sensing deceleration of the vehicle before the corner and re-acceleration thereof from the exit of the corner, or deceleration and stop of the vehicle before an intersection where the traffic signal is at red and starting and acceleration thereof when the traffic signal changes to green, for example.

Further preferably, the environmental information represents information sensed by a navigation device.

According to the present invention, in the navigation device, for example, environmental information such as a road condition around the area where the vehicle is currently running or a road condition around the area where the vehicle will run in the near future can be sensed based on information on a current position of the vehicle and a map state.

Further preferably, the environmental information represents information sensed by a radar device.

According to the present invention, for example, by sensing a distance from a preceding running vehicle and a relative velocity with a radar device, environmental information such as a relation between the preceding running vehicle and one's own vehicle (tracking state) in the near future can be sensed.

Further preferably, the manipulation request is obtained by sensing an operated amount as to an accelerator manipulation and a brake manipulation by a driver.

According to the present invention, for example, an operated amount as to an accelerator manipulation corresponding to a basic operation “running” and a brake manipulation corresponding to a basic operation “stopping” in the vehicle is sensed, so that the driving system control unit and the brake system control unit can be controlled in an integrated manner.

Further preferably, the manipulation request is obtained by sensing an operated amount as to an accelerator manipulation, a brake manipulation, and a transmission manipulation by a driver.

According to the present invention, for example, in addition to the accelerator manipulation corresponding to a basic operation “running” and the brake manipulation corresponding to a basic operation “stopping” in the vehicle, an operated amount of transmission determining a degree of acceleration/deceleration is sensed, so that the driving system control unit (engine, drive motor, and transmission) and the brake system control unit (wheel brake) can be controlled in an integrated manner.

### BRIEF DESCRIPTION OF THE DRAWINGS

FIG. 1 is a block diagram of a vehicle in which the vehicle integrated control system of the present embodiment is incorporated.

FIG. 2 is a schematic diagram of a configuration of the vehicle integrated control system according to the present embodiment.

FIG. 3 is a schematic diagram of a configuration of a main control system (1).

FIG. 4 is a diagram representing the input and output of signals in a main control system (1).

FIG. 5 is a diagram representing the input and output of signals in a main control system (2).

FIG. 6 is a diagram representing the input and output of signals in a main control system (3).

FIG. 7 is a flowchart showing a control configuration of a main program executed in an ECU implementing an advisor unit.

FIGS. 8 to 10 are flowcharts showing control configurations of a sub routine program executed in the ECU implementing the advisor unit.

### BEST MODES FOR CARRYING OUT THE INVENTION

An embodiment of the present invention will be described hereinafter with reference to the drawings. The same elements have the same reference characters allotted. Their label and function are also identical. Therefore, detailed description thereof will not be repeated.

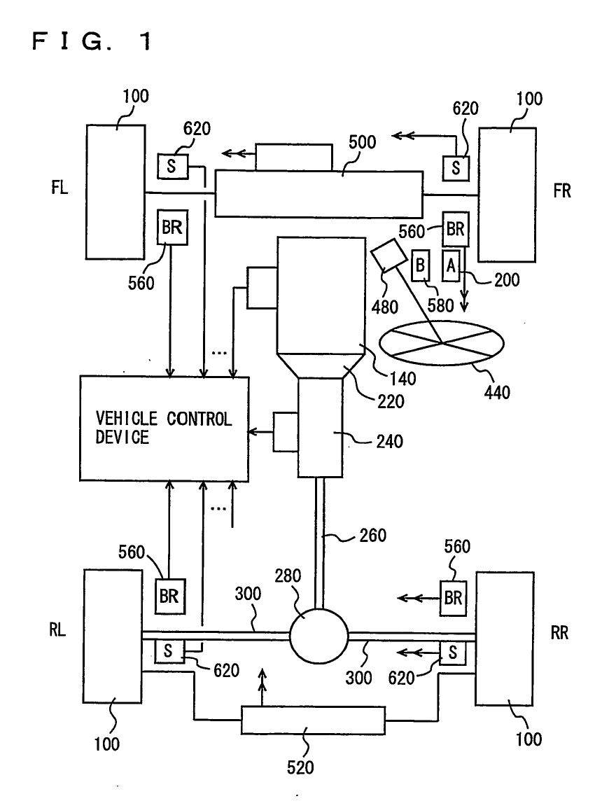

Referring to the block diagram of FIG. 1, a vehicle integrated control system according to an embodiment of the present invention has an internal combustion engine incorporated in a vehicle as a driving power source. The driving power source is not restricted to an internal combustion engine, and may be an electric motor alone, or a combination of an engine and an electric motor. The power source of the electric motor may be a secondary battery or a cell.

The vehicle includes wheels 100 at the front and back of respective sides. In FIG. 1, “FL” denotes a front-left wheel, “FR” denotes a front-right wheel, “RL” denotes a left-rear wheel, and “RR” denotes a rear-right wheel.

The vehicle incorporates an engine 140 as a power source. The operating state of engine 140 is electrically controlled in accordance with the amount or level by which the accelerator pedal (which is one example of a member operated by the driver related to the vehicle drive) is manipulated by the driver. The operating state of engine 140 is controlled automatically, as necessary, irrespective of the manipulation of accelerator pedal 200 by the driver (hereinafter referred to as “driving operation” or “accelerating operation”).

The electric control of engine 140 may be implemented by, for example, electrically controlling an opening angle (that is, a throttle opening) of a throttle valve disposed in an intake manifold of engine 140, or by electrically controlling the amount of fuel injected into the combustion chamber of engine 140.

The vehicle of the present embodiment is a rear-wheel-drive vehicle in which the right and left front wheels are driven wheels, and the right and left rear wheels are driving wheels. Engine 140 is connected to each of the rear wheels via a torque converter 220, a transmission 240, a propeller shaft 260 and a differential gear unit 280 as well as a drive shaft 300 that rotates with each rear wheel, all arranged in the order of description. Torque converter 220, transmission 240, propeller shaft 260 and differential gear 280 are power transmitting elements that are common to the right and left rear wheels.

Transmission 240 includes an automatic transmission that is not shown. This automatic transmission electrically controls the gear ratio at which the revolution speed of engine 140 is changed to the speed of rotation of an output shaft of transmission 240.

The vehicle further includes a steering wheel 440 adapted to be turned by the driver. A steering reaction force applying device 480 electrically applies a steering reaction force corresponding to a turning manipulation by the driver (hereinafter, referred to as “steering”) to steering wheel 440. The level of the steering reaction force is electrically controllable.

The direction of the right and left front wheels, i.e. the front-wheel steering angle is electrically altered by a front steering device 500. Front steering device 5O controls the front-wheel steering angle based on the angle, or steering wheel angle, by which steering wheel 440 is turned by the driver. The front-rear steering angle is controlled automatically, as necessary, irrespective of the turning operation. In other words, steering wheel 440 is mechanically insulated from the right and left front wheels.

The direction of the left and right wheels, i.e., the rear-wheel steering angle is electrically altered by a rear steering device 520, likewise the front-wheel steering angle.

Each wheel 100 is provided with a brake 560 that is actuated so as to restrict its rotation. Each brake 560 is electrically controlled in accordance with the operated amount of a brake pedal 580 (which is one example of a member operated by the driver related to vehicle braking), and also controlled individually for each wheel 100 automatically.

In the present vehicle, each wheel 100 is suspended to the vehicle body (not shown) via each suspension 620. The suspending characteristics of respective suspension 620 are electrically controllable individually.

The constituent elements of the vehicle set forth above include an actuator adapted to be operated so as to electrically actuate respective elements as follows:

(1) An actuator to electrically control engine 140;

(2) An actuator to electrically control transmission 240;

(3) An actuator to electrically control steering reaction force applying device 480;

(4) An actuator to electrically control front steering device 500;

(5) An actuator to electrically control rear steering device 520;

(6) A plurality of actuators provided in association with respective brakes 560 to electrically control the braking torque applied to each wheel by a corresponding brake 560 individually;

(7) A plurality of actuators provided in association with respective suspensions 620 to electrically control the suspending characteristics of a corresponding suspension 620 individually.

As shown in FIG. 1, the vehicle integrated control system is incorporated in a vehicle having the aforesaid plurality of actuators connected. The motion control device is actuated by the electric power supplied from a battery not shown (which is an example of the vehicle power supply).

Additionally, an accelerator pedal reaction force applying device may be provided for accelerator pedal 200. In this case, an actuator to electrically control such an accelerator pedal reaction force applying device is to be provided.

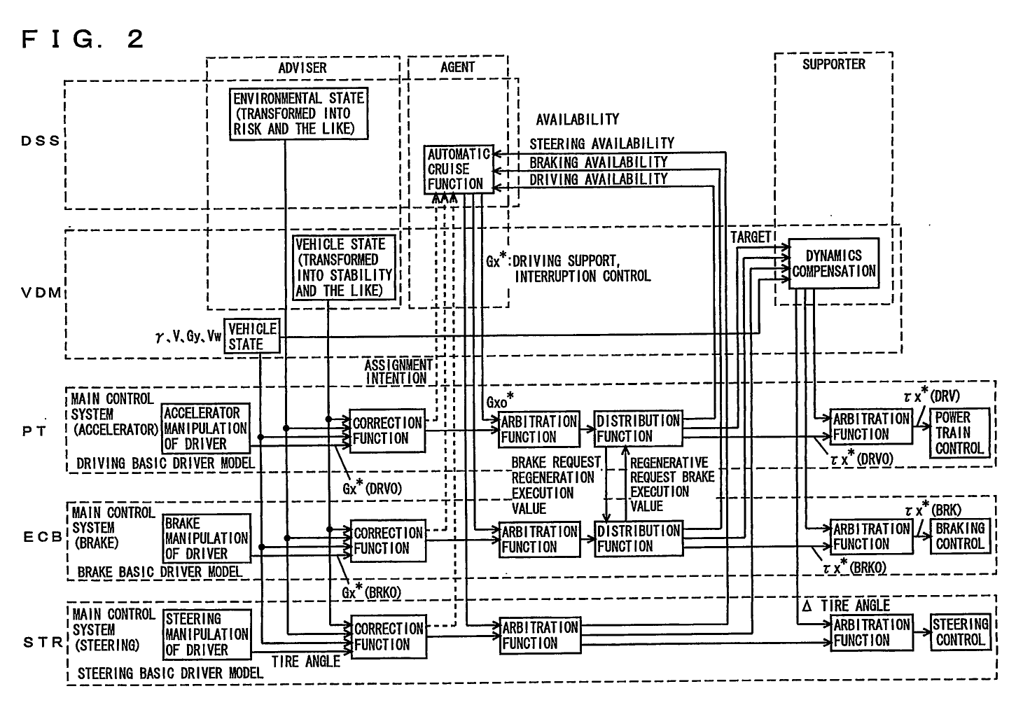

FIG. 2 is a schematic diagram of a configuration of the vehicle integrated control system. The vehicle integrated control system is formed of three basic control units, i.e. a main control system (1) as the driving system control unit, a main control system (2) as the brake system control unit, and a main control system (3) as the steering system control unit.

At main control system (1) identified as the driving system control unit, a control target of the driving system corresponding to accelerator pedal manipulation is generated using the driving basic driver model, based on the accelerator pedal manipulation that is the sensed request of the driver, whereby the actuator is controlled. At main control system (1), the input signal from the sensor to sense the accelerator pedal operated level of the driver (stroke) is analyzed using the drive basic model to calculate a target longitudinal acceleration Gx* (DRV0). The target longitudinal acceleration Gx* (DRV0) is corrected by a correction functional block based on the information from an adviser unit. Further, target longitudinal acceleration Gx* (DRV0) is arbitrated by the arbitration functional block based on the information from an agent unit. Further, the driving torque and braking torque is distributed with main control system (2), and the target driving torque τx* (DRV0) of the driving side is calculated. Further, the target driving torque τx* (DRV0) is arbitrated by the arbitration functional block based on information from a supporter unit, and a target driving torque τx* (DRV) is calculated. The power train (140, 220, 240) is controlled so as to develop this target drive torque τx* DRV).

At main control system (2) identified as the brake system control unit, a control target of the brake system corresponding to the brake pedal manipulation is generated using the brake basic driver model based on the brake pedal manipulation that is the sensed request of the driver, whereby the actuator is controlled.

At main control system (2), the input signal from a sensor to sense the brake pedal manipulated level (depression) of the driver is analyzed using a brake basic model to calculate a target longitudinal acceleration Gx* (BRK0). At main control system (2), the target longitudinal acceleration Gx* (BRK0) is corrected by a correction functional block based on the information from the adviser unit. Further at main control system (2), the target longitudinal acceleration Gx* (BRK0) is arbitrated by the arbitration functional block based on the information from the agent unit. Further at main control system (2), the driving torque and the braking torque are distributed with main control system (1), and the target braking torque τx* (BRK0) of the braking side is calculated. Further, the target braking torque τx* (BRK0) is arbitrated by the arbitration functional block based on the information from the support unit, and target braking torque τx* (BRK) is calculated. The actuator of brake 560 is controlled so as to develop this target braking torque τx* (BRK).

At main control system (3) identified as the steering system control unit, a control target of the steering system corresponding to the steering manipulation is generated using the steering brake basic driver model based on the steering manipulation that is the sensed request of the driver, whereby the actuator is controlled.

At main control system (3), an input signal from the sensor to sense the steering angle of the driver is analyzed using a steering basic model to calculate a target tire angle. The target tire angle is corrected by the correction functional block based on the information from the adviser unit. Further, the target tire angle is arbitrated by the arbitration functional block based on the information from the agent unit. Further, the target tire angle is arbitrated by the arbitration functional block based on the information from the supporter unit to calculate the target tire angle. The actuators of front steering device 500 and rear steering device 520 are controlled so as to develop the target tire angle.

Furthermore, the present vehicle integrated control system includes a plurality of processing units parallel to main control system (1) (driving system control unit), main control system (2) (brake system unit) and main control system (3) (steering system control unit), operating autonomously. The first processing unit is an adviser unit with an adviser function. The second processing unit is an agent unit with an agent function. The third processing unit is a support unit with a supporter function.

The adviser unit generates and provides to respective main control systems information to be used at respective main control systems based on the environmental information around the vehicle or information related to the driver. The agent unit generates and provides to respective main control systems information to be used at respective main control systems to cause the vehicle to realize a predetermined behavior. The supporter unit generates and provides to respective main control systems information to be used at respective main control systems based on the current dynamic state of the vehicle. At respective main control systems, determination is made as to whether or not such information input from the adviser unit, the agent unit and the supporter unit (information other than the request of the driver) is to be reflected in the motion control of the vehicle, and to what extent, if to be reflected. Furthermore, the control target is corrected, and/or information is transmitted among respective control units. Since each main control system operates autonomously, the actuator of the power train, the actuator of brake device and the actuator of steering device are controlled eventually at respective control units based on the eventual driving target, braking target and steering target calculated by the sensed manipulation information of the driver, information input from the adviser unit, agent unit and supporter unit, and information transmitted among respective main control systems.

Specifically, the adviser unit generates information representing the degree of risk with respect to the vehicle operation property based on the frictional resistance (μ value) of the road on which the vehicle is running, the outdoor temperature and the like as the environmental information around the vehicle, and/or generates information representing the degree of risk with respect to the manipulation of the driver based on the fatigue level of the driver upon shooting a picture of the driver. Information representing the degree of risk is output to each main control system. This information representing the degree of risk is processed at the adviser unit so the information can be used at any of the main control systems. At each main control system, the process is carried out as to whether or not to reflect the information related to the input risk for the vehicle motion control, in addition to the request of the driver from the processing unit, and to what extent the information is to be reflected, and the like.

Specifically, the agent unit generates information to implement an automatic cruise function for the automatic drive of vehicle. The information to implement the automatic cruise function is output to each main control system. At each main control system, the process is carried out as to whether or not to reflect the input information to implement the automatic cruise function, in addition to the request of the driver from the processing unit, and to what extent the information is to be reflected, and the like.

Further preferably, the supporter unit identifies the current dynamic state of the vehicle, and generates information to modify the target value at each main control system. The information to modify the target value is output to each main control system. At each main control system, the process is carried out as to whether or not to reflect the input information to modify the target value based on the dynamic state for the vehicle motion control, in addition to the request of the driver from the processing unit, and to what extent the information is to be reflected, and the like.

As shown in FIG. 2, the basic control units of main control system (1), main control system (2) and main control system (3), and the support unit of the adviser unit, agent unit, and supporter unit are all configured so as to operate autonomously. Main control system (1) is designated as the PT (Power Train) system. Main control system (2) is designated as the ECB (Electronic Controlled Brake) system. Main control system (3) is designated as the STR (Steering) system. A portion of the adviser unit and the portion of the agent unit are designated as the DSS (Driving Support System). A portion of the adviser unit, a portion of the agent unit, and a portion of the supporter unit are designated as the VDM (Vehicle Dynamics Management) system. Interruption control for intervention of control executed at main control system (1), main control system (2) and main control system (3) from the agent unit (automatic cruise function) is conducted in the control shown in FIG. 2.

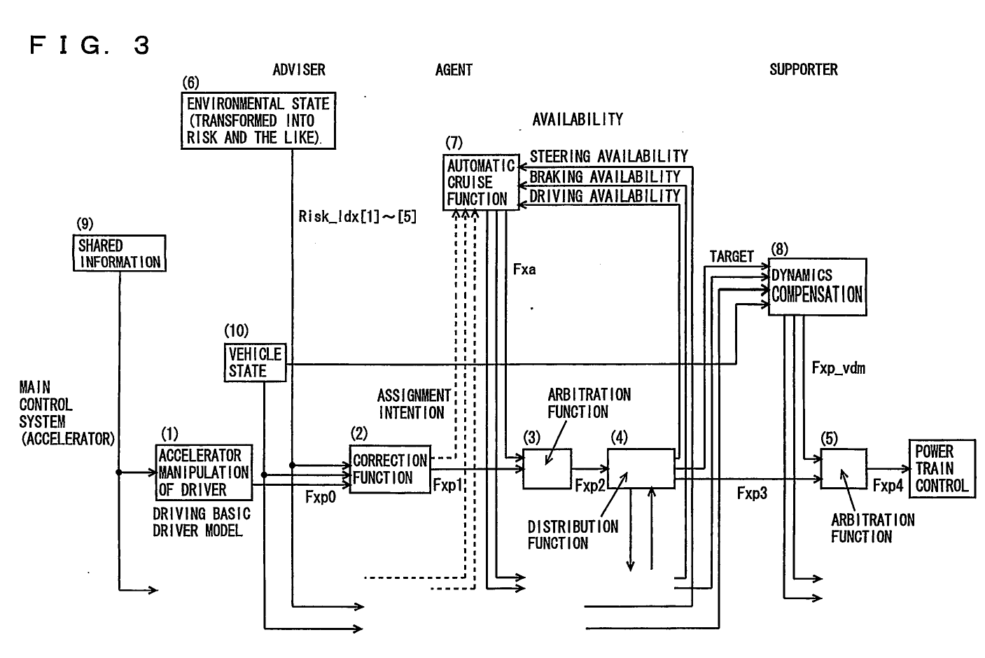

Main control system (1) (driving system control unit) will be described in further detail with reference to FIG. 3. Although the designation of the variable labels may differ in FIGS. 3 and et seq., there is no essential difference thereby in the present invention. For example, the interface is designated as Gx* (acceleration) in FIG. 2 whereas the interface is designated as Fx (driving force) in FIGS. 3 and et seq. This corresponds to F (force)=m (mass)×α(acceleration), where the vehicle mass (m) is not the subject of control, and is not envisaged of being variable. Therefore, there is no essential difference between Gx* (acceleration) of FIG. 2 and Fx (driving force) of FIGS. 3 and et seq.

Main control system (1) that is the unit to control the driving system receives information such as the vehicle velocity, gear ratio of the transmission and the like identified as shared information (9). Using such information and the driving basic driver model, Fxp0 representing the target longitudinal direction acceleration is calculated as the output of the driving basic driver model. The calculated Fxp0 is corrected to Fxp1 by a correction functional unit (2) using environmental state (6) that is the risk degree information (index) as an abstraction of risk and the like, input from the adviser unit. Information representing the intention of assignment with respect to realizing an automatic cruise function is output from correction functional unit (2) to agent unit (7). Using Fxp1 corrected by correction functional unit (2) and information for implementation of automatic cruise functional unit (7), input from the agent unit, the information (Fxp1, Fxa) is arbitrated by arbitration functional unit (3) to Fxp2.

The dividing ratio of the driving torque and braking torque is calculated between main control system (1) that is the unit controlling the driving system and main control system (2) that is the unit driving the brake system. At main control system (1) corresponding to the driving unit side, Fxp3 of the driving system is calculated. FxB is output from distribution functional unit (4) to main control system (2), and the driving availability and target value are output to agent unit (7) and dynamic (8) that is the supporter unit, respectively.

At arbitration functional unit (5), the information is arbitrated to Fxp4 using Fxp3 output from distribution functional unit (4) and Fxp_vdm from dynamics compensation functional unit (8). Based on the arbitrated Fxp4, the power train is controlled.

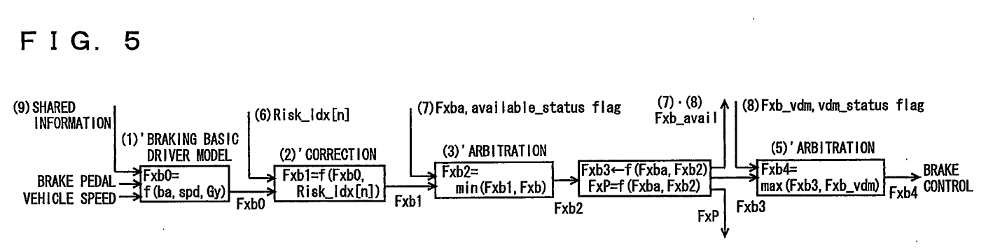

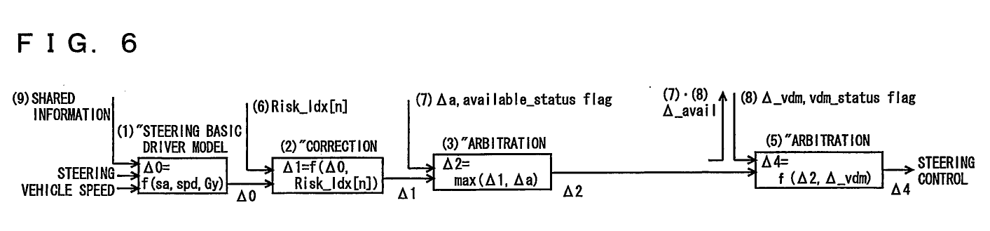

The elements shown in FIG. 3 are also present in main control system (2) and main control system (3). Since main control system (2) and main control system (3) will be described in further detail with reference to FIGS. 5-6, description on main control system (2) and main control system (3) based on drawings corresponding to main control system (1) of FIG. 3 will not be repeated.

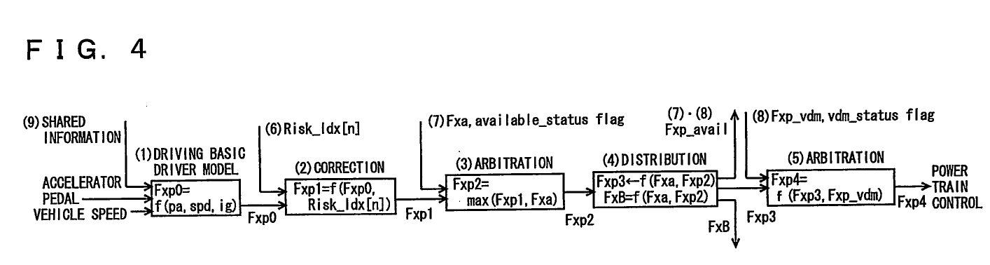

FIGS. 4-6 represent the control configuration of main control system (1), main control system (2) and main control system (3).

FIG. 4 shows a control configuration of main control system (1). Main control system (1) that covers control of the driving system is adapted by the procedures set forth below.

At driving basic driver model (1), the basic drive driver model output (Fxp0) is calculated based on HMI (Human Machine Interface) input information such as the accelerator pedal opening angle (pa), vehicle speed (spd) and gear ratio (ig) of the transmission that are shared information (9), and the like. The equation at this stage is represented by Fxp0=f (pa, spd, ig), using function f At correction functional unit (2), Fxp0 is corrected to output Fxp1 based on Risk_Idx [n] that is the environmental information (6) from the advisor unit (for example, information transformed into the concept of risk or the like). The equation at this stage is represented by Fxp1=f (Fxp0, Risk_Idx [n]), using function f.

Specifically, it is calculated by, for example, Fxp11=Fxp0×Risk_Idx [n]. The degree of risk is input from the advisor unit such as Risk_Idx [1]=0.8, Risk_Idx [2]=0.6, and Risk_Idx [3]=0.5.

Additionally, Fxp12 is calculated, which is a corrected version of Fxp0, based on information that is transformed into the concept of stability and the like from the vehicle state (10). The equation at this stage is represented by, for example, Fxp12=Fxp0×StableIdx [n]. The stability is input such as Stable_Idx [1]0.8, Stable_Idx [2]=0.6, and Stable_Idx [3]=0.5.

A smaller value of these Fxp11 and Fxp12 may be selected to be output as Fxp1.

In this correction functional unit (2), assignment intention information can be output to automatic cruise functional unit (7) that is an agent function when the driver depresses the cruise control switch. In the case where the accelerator pedal is a reaction force controllable type here, the automatic cruise intention of the driver is identified based on the driver's manipulation with respect to the accelerator pedal to output assignment intention information to automatic cruise functional unit (7).

At arbitration functional unit (3), arbitration between Fxp1 output from correction functional unit (2) and Fxa output from automatic cruise functional unit (7) of the agent unit is executed to output Fxp2 to distribution unit (4). When accompanied with additional information (flag, available_status flag) indicative of output Fxa from automatic cruise functional unit (7) being valid, the arbitration function selects Fxa that is the output from automatic cruise functional unit (7) with highest priority to calculate Fxp2. In other cases, Fxp1 that is the output from correction functional unit (2) may be selected to calculate Fxp2, or Fxp1 output from correction function unit (2) may have Fxa reflected at a predetermined degree of reflection to calculate Fxp2. The equation at this stage is represented by Fxp2=max (Fxp1, Fxa), for example, using a function “max” that selects the larger value.

At distribution functional unit (4), distribution operation is mainly effected between main control system (1) that is the driving system control unit and main control system (2) that is the brake system control unit. Distribution functional unit (4) functions to output Fxp3 to arbitration functional unit (5) for the distribution towards the driving system that is the calculated result, and outputs FxB to main control system (2) for the distribution towards the brake system that is the calculated result. Further, drive availability Fxp_avail identified as the information of the driving power source that can be output from the power train which is the subject of control of main control system (1) is provided to automatic cruise functional unit (7) identified as the agent unit and dynamics compensation functional unit (8) identified as the supporter unit. The equation at this stage is represented by Fxp3←f (Fxa, Fxp2), FxB=f (Fxa, Fxp2), using function f.

At arbitration functional unit (5), arbitration is executed between Fxp3 output from distribution functional unit (4) and Fxp_vdm output from dynamics compensation functional unit (8) to output Fxp4 to the power train controller. When accompanied with additional information (flag, vdm_status flag) indicative of Fxp_vdm output from dynamics compensation functional unit (8) being valid, the arbitration function selects Fxp_vdm that is the output from dynamics compensation functional unit (8) with highest priority to calculate Fxp4. In other cases, Fxp3 that is the output from distribution functional unit (4) can be selected to calculate Fxp4, or Fxp3 output from distribution functional unit (4) may have Fxp_vdm reflected by a predetermined degree of reflection to calculate Fxp4. The equation at this stage is represented by, for example, Fxp4=f (Fxp3, Fxp_vdm).

FIG. 5 represents the control configuration of main control system (2). Main control system (2) covering the control of the brake system is adapted by the procedure set forth below.

At the brake basic driver model (1)′, the basic braking driver model output (Fxp0) is calculated based on the HMI input information such as the brake pedal depression (ba), as well as vehicle speed (spd), that is the shared information (9), the horizontal G acting on the vehicle (Gy), and the like. The equation at this stage is represented by Fxb0=f (pa, spd, Gy), using function f.

At correction function unit (2)′, Fxb0 is corrected to output Fxb1 based on Risk_Idx [n] that is the environmental information (6) from the advisor unit (for example, information transformed into the concept of risk and the like). The equation at this stage is represented by Fxb1=f (Fxb0, Risk_Idx [n]), using function f.

More specifically, it is calculated by, for example, Fxb11=Fxb0×Risk_Idx [n]. The degree of risk is input from the advisor unit such as Risk_Idx [1]=0.8, Risk_Idx [2]=0.6, and Risk_Idx [3]=0.5.

Further, Fxb12 that is a corrected version of Fxb0 is calculated, based on information transformed into the concept of stability and the like from the vehicle state (10). It is calculated by, for example, Fxb12=Fxb0×Stable_Idx [n]. For example, Stable_Idx [1]=0.8, Stable_Idx [2]=0.6, and Stable_Idx [3]=0.5 are input.

The larger of these Fxb11 and Fxb12 may be selected to be output as Fxb1. Specifically, the output may be corrected in accordance with the distance from the preceding running vehicle sensed by a millimeter wave radar, the distance to the next corner sensed by the navigation device, or the like.

At arbitration functional unit (3)′, arbitration is executed between Fxb1 output from correction functional unit (2)′ and Fxba output from automatic cruise functional unit (7) that is the agent unit to output Fxb2 to distribution unit (4)′. When accompanied with additional information (flag, available_status flag) indicative of Fxba output from automatic cruise functional unit (7) being valid, the arbitration function selects Fxba that is the output from automatic cruise functional unit (7) with highest priority to calculate Fxb2. In other cases, Fxb1 that is the output from correction functional unit (2)′ may be selected to calculate Fxb2, or Fxb1 that is the output from correction functional unit (2)′ may have Fxba reflected by a predetermined degree of reflection to calculate Fxb2. The equation at this stage is represented by, for example, Fxb2 =max (Fxb1, Fxba), using a function “max” that selects the larger value.

At distribution functional unit (4)′, distribution operation is conducted between main control system (1) that is the driving system control unit and main control system (2) that is the brake system control unit. Functional distribution unit (4)′ corresponds to distribution functional unit (4) of main control system (1). Distribution functional unit (4)′ outputs Fxb3 to arbitration functional unit (5)′ for distribution towards the brake system that is the calculated result, and outputs FxP to main control system (1) for distribution towards the driving system that is the calculated result. Further, brake availability Fxb_avail identified as information that can be output from the brake that is the subject of control of main control system (2) is provided to automatic cruise functional unit (7) identified as the agent unit and dynamics compensation functional unit (8) identified as the supporter unit. The equation at this stage is represented by Fxb3←f (Fxba, Fxb2), FxP=f (Fxba, Fxb2), using function f.

Arbitration functional unit (5)′ executes arbitration between Fxb3 output from distribution functional unit (4)′ and Fxb_vdm output from dynamics compensation functional unit (8) that is the support unit to output Fxb4 to the brake controller. When accompanied with additional information (flag, vdm_status flag) indicative of Fxb_vdm output from dynamics compensation functional unit (8) being valid, the arbitration function selects Fxb_vdm that is the output from dynamics compensation functional unit (8) with highest priority to calculate Fxb4. In other cases, Fxb3 that is the output from distribution functional unit (4)′ may be selected to calculate Fxb4, or Fxb3 output from distribution functional unit (4)′ may have Fxb_vdm reflected by a predetermined degree of reflection to calculate Fxb4. The equation at this stage is represented by, for example, Fxb4=max (Fxb3, Fxb_vdm), using a function “max” that selects the larger value.

FIG. 6 shows a control configuration of main control system (3). Main control system (3) covering control of the steering system is adapted to control by the procedure set forth below.

At steering basic driver model (1)″, basic steering driver model output (Δ0) is calculated based on HMI input information such as the steering angle (sa), vehicle speed (spd) that is shared information (9), horizontal G acting on the vehicle (Gy), and the like. The equation at this stage is represented by Δ0=f (sa, spd, Gy), using function f.

At correction functional unit (2)″, Δ0 is corrected to output Δ1 based on Risk_Idx [n] that is environmental information (6) from the adviser unit (for example, information transformed into the concept of risk, and the like). The equation at this stage is represented by Δ1=f (Δ0, Risk_Idx [n]), using function f.

Specifically, it is calculated by Δ11=Δ0×Risk_Idx [n]. The degree of risk is input from the adviser unit such as Risk_Idx [n]=0.8, Risk_Idx [2]=0.6, and Risk_Idx [3]=0.5.

Further, Δ12 that is a corrected version of Δ0 is calculated based on information transformed into the concept of stability and the like from the vehicle state (10). The equation at this stage is represented by Δ12=Δ0×Stable_Idx [n]. For example, Stable_Idx [1]=0.8, Stable_Idx [2]=0.6, and Stable_Idx [3]=0.5 are input.

The smaller of these Δ11 and Δ12 may be selected to be output as Δ1.

At correction functional unit (2)″, assignment intention information to automatic cruise functional unit (7) that is the agent function can be output when the driver has depressed the lane keep assist switch. Furthermore, the output may be corrected in accordance with an external disturbance such as the side wind at correction functional unit (2)″.

At arbitration functional unit (3)″, arbitration is executed between Al output from correction functional unit (2)″ and Δa output from automatic cruise functional unit (7) that is the agent unit to output Δ2 to arbitration unit (5)″. When accompanied with additional information (flag, available_status flag) indicative of Δa that is the output from automatic cruise functional unit (7) being valid, the arbitration function selects Δa that is the output from automatic cruise functional unit (7) with the highest priority to calculate Δ2. In other cases, Δ1 that is the output from correction functional unit (2)″ may be selected to calculate Δ2, or Δ1 that is the output from correction functional unit (2)″ may have Δa reflected by a predetermined degree of reflection to calculate Δ2. The equation at this stage is represented by, for example, Δ2=f(Δ1, Δa).

At arbitration functional unit (5)″, arbitration is executed between Δ2 output from arbitration functional unit (3)″ and Δ_vdm output from dynamics compensation function unit (8) that is the supporter unit to provide Δ4 to the steering controller. When accompanied with additional information (flag, vdm_status flag) indicative of Δ_vdm output from dynamics compensation functional unit (8) being valid, the arbitration function selects Δ_vdm that is the output from dynamics compensation functional unit (8) with highest priority to calculate Δ4. In other cases, Δ2 may be selected that is the output from arbitration functional unit (3)″ to calculate Δ4, or Δ2 that is the output from arbitration functional unit (3)″ may have Δ_vdm reflected by a predetermined degree of reflection to calculate Δ4. The equation at this stage is represented by, for example, Δ4=max (Δ2, Δ_vdm), using a function “max” that selects the larger value.

The operation of a vehicle incorporating the integrated control system set forth above will be described hereinafter.

During driving, the driver manipulates accelerator pedal 200, brake pedal 580 and steering wheel 440 to control the driving system control unit corresponding to the “running” operation that is the basic operation of a vehicle, the brake system control unit corresponding to the “stop” operation, and the steering system control unit corresponding to a “turning” operation, based on information obtained by the driver through his/her own sensory organs (mainly through sight). Basically, the driver controls the vehicle through HIM input therefrom. There may also be the case where the driver manipulates the shift lever of the automatic transmission to modify the gear ratio of transmission 240 in an auxiliary manner.

During the drive of a vehicle, various environmental information around the vehicle is sensed by various devices incorporated in the vehicle, in addition to the information obtained by the driver through his/her own sensory organs. The information includes, by way of example, the distance from the vehicle running ahead, sensed by a millimeter wave radar, the current vehicle position and the road state ahead (corner, traffic jam, and the like) sensed by the navigation device, the road inclination state sensed by a G sensor (level road, up-climbing road, down-climbing road), the outdoor temperature of vehicle sensed by an outdoor temperature sensor, local weather information of the current running site received from a navigation device equipped with a receiver, the road resistance coefficient (low μ road state and the like by road surface freezing state), the running state of the vehicle ahead sensed by a blind corner sensor, a lane-keep state sensed based upon an image-processed picture taken by an outdoor camera, the driving state of the driver sensed based upon an image-processed picture taken by an indoor camera (driver posture, wakeful state, nod-off state), the dosing state of a driver sensed by sensing and analyzing the grip of the driver's hand by a pressure sensor provided at the steering wheel, and the like. These pieces of information are divided into environmental information around the vehicle, and information about the driver himself/herself. It is to be noted that both information are not sensed through the sensory organs of the driver.

Furthermore, the vehicle dynamic state is sensed by a sensor provided at the vehicle. The information includes, by way of example, wheel speed Vw, vehicle speed in the longitudinal direction Vx, longitudinal acceleration Gx, lateral acceleration Gy, yaw rate y, and the like.

The present vehicle incorporates a cruise control system and a lane-keep assist system as the driving support system to support the driver's drive. These systems are under control of the agent unit. It is expected that a further development of the agent unit will lead to implementation of a complete automatic cruising operation, exceeding the pseudo automatic cruising. The integrated control system of the present embodiment is applicable to such cases. Particularly, implementation of such an automatic cruising system is allowed by just modifying the automatic cruise function of the agent unit to an automatic cruise function of a higher level without modifying the driving system control unit corresponding to main control system (1), the brake system control unit corresponding to main control system (2), the steering system control unit corresponding to main control system (3), the adviser unit, and the supporter unit.

Consider a case where there is a corner ahead in the currently-running road during driving. This corner cannot be identified by the eye sight of the driver, and the driver is not aware of such a corner. The adviser unit of the vehicle senses the presence of such a corner based on information from a navigation device.

When the driver steps on accelerator pedal 200 for acceleration in the case set forth above, the driver will depress brake pedal 580 subsequently to reduce the speed of the vehicle at the corner. At main control system (1), the basic drive driver model output Fxp0 is calculated by Fxp0=f (pa, spd, ig), based on the accelerator pedal opening angle (pa), vehicle speed (spd), gear ratio of the transmission (ig), and the like. Conventionally, a large request driving torque value will be calculated based on this FxP0 to cause opening of the throttle valve of engine 140, and/or reducing the gear ratio of transmission 240 to cause vehicle acceleration. In the present invention, the adviser unit calculates the degree of risk Risk_Idx [n] based on the presence of the corner ahead and outputs this information to correction functional unit (2). Correction functional unit (2) performs correction such that acceleration is not exhibited as the driver will expect from his/her depression on accelerator pedal 200.

When the supporter unit senses that the road surface is freezing and there is a possibility of slipping sideways by the vehicle longitudinal acceleration at this stage, Stable_Idx [n] that is the degree of risk related to stability is calculated and output to correction functional unit (2). Thus, correction functional unit (2) performs correction such that acceleration is not exhibited as the driver will expect from his/her depression on accelerator pedal 200.

When slippage of the vehicle is sensed, the supporter unit outputs to arbitration functional unit (5) a signal that will reduce the driving torque. In this case, Fxp_vdm from the supporter unit is employed with priority such that the power train is controlled to suppress further slippage of the vehicle. Therefore, even if the driver steps on accelerator pedal 200 greatly, arbitration is established such that the acceleration is not exhibited as the driver will expect from his/her depression on accelerator pedal 200.

Such a vehicle integrated control system will further specifically be described.

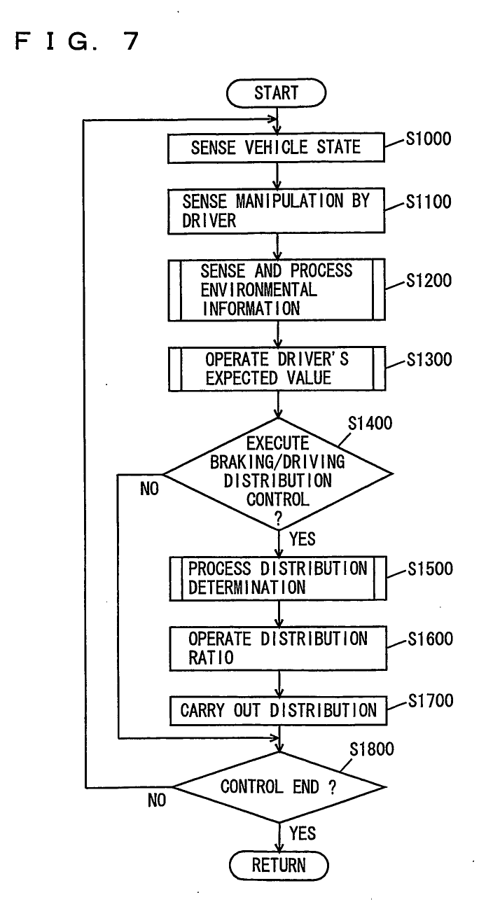

Referring to FIG. 7, a control configuration of a program executed in an ECU implementing an advisor unit, for example, in the vehicle integrated control system according to the present embodiment will be described. The flowchart shown in FIG. 7 or later may be executed in another ECU instead of the ECU implementing the advisor unit.

At step (hereinafter, step is abbreviated as “S”) S1000, the ECU of the advisor unit senses a vehicle state. Here, a vehicle speed, an engine speed of engine 140, and an engine torque of engine 140 and a driving torque of the vehicle are sensed, for example. At S1100, the ECU of the advisor unit senses a manipulation by the driver, such as an amount of pressing of the accelerator pedal or the brake pedal. In addition, a manipulation to designate a transmission gear of transmission 240 may be sensed.

At S1200, the ECU of the advisor unit senses the environmental information and executes the processing of the environmental information. Detailed description of the processing will be provided later.

At S1300, the ECU of the advisor unit operates a driver's expected value. This operation represents a processing to operate acceleration/deceleration or a driving torque expected by the driver for the vehicle. Detailed description of the processing will be provided later.

At S1400, the ECU of the advisor unit determines whether or not braking/driving distribution control is to be executed. This determination refers to a processing to determine whether or not braking/driving distribution control after S1500 or later is to be executed, based on the information from the agent unit, the supporter unit, or the main control system unit. If it is determined that braking/driving distribution control is executed (YES at S1400), the process proceeds to S1500. Otherwise (NO at S1400), the process proceeds to S1800.

At S1500, the ECU of the advisor unit performs distribution determination processing for the main control system (accelerator) serving as the drive system and the main control system (brake) serving as the brake system. Detailed description of the processing will be provided later.

At S1600, the ECU of the advisor unit operates a distribution ratio between the driving torque and the braking torque. Basically, such a ratio of distribution to respective systems (main control system (accelerator) and main control system (brake)) as to optimize the vehicle motion is determined such that requested acceleration or requested driving torque is attained.

At S1700, the ECU of the advisor unit carries out distribution based on the ratio of distribution to respective systems (main control system (accelerator) and main control system (brake)) determined at S1700.

At S1800, the ECU of the advisor unit determines whether or not the control is to be ended. If the control is ended (YES at S1800), the process ends. Otherwise (NO at S1800), the process returns to S1000.

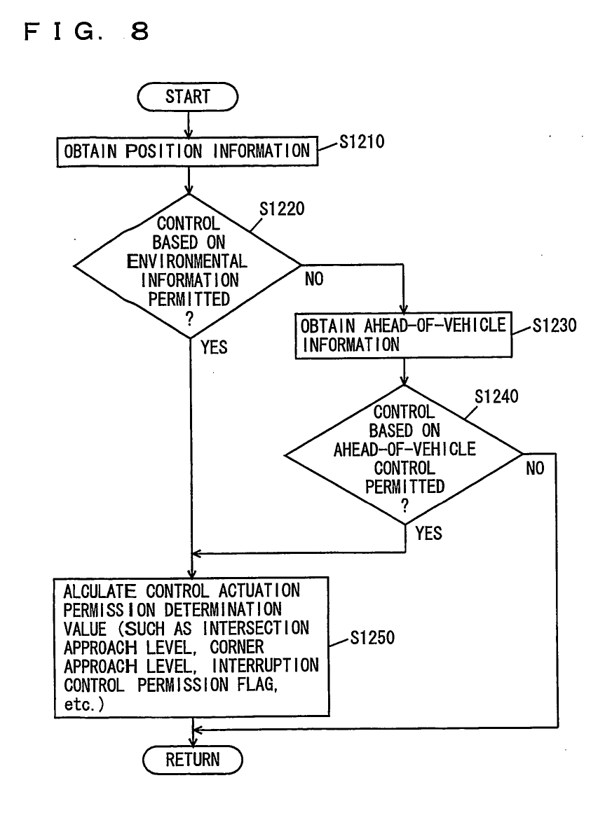

Referring to FIG. 8, the processing at S1200 in FIG. 7 will be described in detail.

At S1210, the ECU of the advisor unit obtains position information. The position information refers to current position information and map information from the navigation device, for example. Based on such information, the ECU of the advisor unit obtains information indicating that the vehicle is currently in a temporary stop state at an intersection or a state that the vehicle is approaching a deceleration area.

At S1220, the ECU of the advisor unit determines whether or not control based on the environmental information is permitted. For example, when the vehicle temporarily stops at an intersection or when the vehicle approaches a corner where the vehicle should decelerate, control based on the environmental information is permitted. If the control based on the environmental information is permitted (YES at S1220), the process proceeds to S1250. Otherwise (NO at S1220), the process proceeds to S1230.

At S1230, the ECU of the advisor unit obtains information indicating vehicle stop or approach to a deceleration-requested area, for example, based on a distance between cars obtained from a millimeter wave radar, or on a current position and a relative velocity with respect to the preceding vehicle. At S1240, the ECU of the advisor unit determines whether or not control based on ahead-of-vehicle information is permitted. When the preceding vehicle is close, for example, it is necessary to stop or decelerate the vehicle. Accordingly, control based on the ahead-of-vehicle information is permitted. If the control based on the ahead-of-vehicle information is permitted (YES at S1240), the process proceeds to S1250. Otherwise (NO at S1240), the process ends.

At S1250, the ECU of the advisor unit calculates a control actuation permission determination value (such as an intersection approach level, a corner approach level, and an interruption control permission flag).

In the flowchart shown in FIG. 8, a control actuation permission determination value is calculated when control based on the environmental information around the vehicle obtained from the navigation device or the like is permitted, or when control based on the ahead-of-vehicle information is permitted. In such a case, it is determined that the driver is requesting large deceleration based on a large brake pressing force, or it is determined that positive increase (shift-down) of the gear ratio of transmission 240 is preferable based on the environmental information (before the corner). In other words, it is determined that a driving device is to be operated in a prioritized manner (in contrast, it is determined that deceleration solely by a brake device is not appropriate), and such control as to modify the gear ratio of transmission 240 using the brake pressing force as a parameter is exerted.

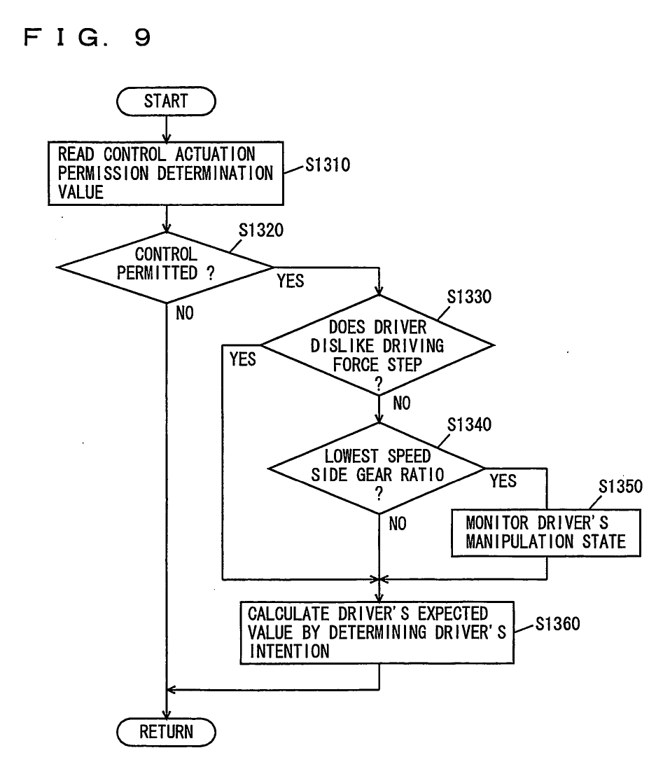

Referring to FIG. 9, the processing at S1300 in FIG. 7 will be described in detail.

At S1310, the ECU of the advisor unit reads the control actuation permission determination value. The control actuation permission determination value has been calculated at S1250 in FIG. 8.

At S1320, the ECU of the advisor unit determines whether or not control is permitted. If the control is permitted (YES at S1320), the process proceeds to S1330. Otherwise (NO at S1320), the process ends.

At S1330, the ECU of the advisor unit determines whether or not the driver dislikes a step in the driving force caused by gear shift. Determination as to whether or not the driver dislikes the step in the driving force is made based on an input of driver's intention to avoid a torque (acceleration) step due to sudden deceleration or gear shift or on estimation thereof through driver's intention input means or driver's intention estimation means. If the driver dislikes the step in the driving force (YES at S1330), the process proceeds to S1360. Otherwise (NO at S1330), the process proceeds to S1340.

At S1340, the ECU of the advisor unit determines whether or not a current gear ratio of transmission 240 is the lowest speed side gear ratio. If the current gear ratio of transmission 240 is the lowest speed side gear ratio (a first gear when a gear type transmission is employed) (YES at S1340), the process proceeds to S1350. Otherwise (NO at S1340), the process proceeds to S1360.

At S1350, the ECU of the advisor unit monitors a state of manipulation by the driver. Here, for example, a state of the brake pedal pressing force by the driver is monitored.

At S1360, the ECU of the advisor unit determines a driver's intention, and calculates a driver's expected value.

In the flowchart shown in FIG. 9, when control is permitted and when the driver dislikes the step in gear shift, the driver's intention is determined and a driver's expected value is calculated. As the driver has the intention to avoid the step in the torque (acceleration) due to sudden deceleration and gear shift, the vehicle is stopped in a state that a second gear or a third gear is set, instead of shifting the gear of transmission 240 down to the first gear in deceleration. Here, as an actuation force of the engine brake is weak, distribution is carried out such that deceleration (acceleration) not satisfied by the main control system (accelerator) in spite of the driver's request is compensated for with the main control system (brake). Such distribution is carried out utilizing a distribution function of the main control system (accelerator) and a distribution function of the main control system (brake) shown in FIG. 2.

In addition, when the gear ratio of transmission 240 is the lowest speed side gear ratio and when a manipulation by the driver to increase the brake pressing force is sensed, it is determined that the driver has strongly pressed down the brake pedal because the driving torque has been large. If such a state is repeated, learning control is realized, and the main control system (accelerator) is controlled so as to attain a lower driving torque side (a side where the gear ratio of transmission 240 is higher). As a result, the vehicle stops in a state that a second gear or a third gear is set, instead of shifting down to the first gear as described above.

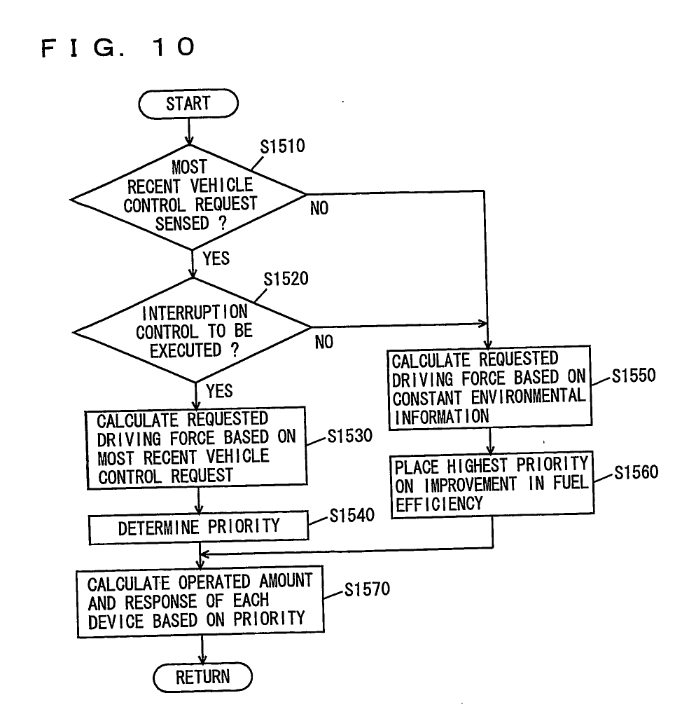

Referring to FIG. 10, the processing at S1500 in FIG. 7 will be described in detail.

At S1510, the ECU of the advisor unit determines whether or not a most recent vehicle control request has been sensed. When an intersection approach level or a corner approach level based on the control actuation permission determination value at S1250 shown in FIG. 8 is high, it is determined that the most recent vehicle control request is present. If the most recent vehicle control request is sensed (YES at S1510), the process proceeds to S1520. Otherwise (NO at S1510), the process proceeds to S1550.

At S1520, the ECU of the advisor unit determines whether or not interruption control is to be executed. Here, the ECU of the advisor unit makes a determination based on an interruption control permission flag calculated at S1250 in FIG. 8. If interruption control is executed (YES at S1520), the process proceeds to S1530. Otherwise (NO at S1520), the process proceeds to S1550.

At S1530, the ECU of the advisor unit calculates a requested driving force based on the most recent vehicle control request. For example, the most recent vehicle control request refers to calculation of the requested driving force for performing an operation to interrupt in control based on position information from a car navigation device when the vehicle is approaching an intersection where it should stop or approaching a corner where it should decelerate.

At S1540, the ECU of the advisor unit determines priority. Priority here refers to priority when respective amounts of device operation of the main control system (accelerator) and the main control system (brake) in order to attain the requested driving force calculated at S1530 are output. When a most recent deceleration request to the vehicle is present, for example, which of response speed and torque fluctuation amount on a power train side (engine 140 and transmission 240, for example) and response speed and absorbed torque amount on brake 560 side can more quickly attain the requested driving force (requested deceleration) is determined, and one attaining better response is selected. That is, higher priority is placed on the one attaining better response. In addition, when the most recent deceleration requested is present and when shift toward a larger driving force side after deceleration can be estimated (deceleration before the corner and acceleration at the exit of the corner), control is exerted such that brake 560 side is also responsible for requested deceleration before the corner, instead of lowering the driving force in the power train (decrease in engine 140 torque and down-shift of transmission 240, for example). Moreover, when control for lowering the torque of engine 140 is being exerted in transmission control of transmission 240, a logic taking into account endurance of a catalyst of engine 140 may be in actuation. In such a case, it is also possible to cause the brake side to be responsible for negative torque generation for attaining the requested deceleration, without employing instantaneous engine torque lowering control (conventional ignition delay).

At S1550, the ECU of the advisor unit calculates the requested driving force based on constant environmental information. At S1560, the ECU of the advisor unit places highest priority on improvement in fuel efficiency.

At S1570, the ECU of the advisor unit calculates an operated amount and response of each device based on the determined priority.

Here, selection of a braking/driving device is made using a map or a function so as to satisfy a request by the driver as much as possible, and distribution control of a power train system and a brake system is carried out.

An operation of a vehicle in these specific examples will now be described based on the above-described configuration and flowcharts.

When braking/driving control shown in the flowchart is carried out during running of the vehicle, a vehicle state is sensed (S1000), and a manipulation by the driver is sensed (S1100). In addition, the environmental information is sensed by the navigation device or the like, and the environmental information is processed (S1200). In processing the environmental information, in addition to control based on global position information obtained from the navigation device or the like, an actuation permission determination value for braking/driving control is calculated based on the most recent control information based on a relation with the preceding vehicle obtained from the millimeter wave radar (S1250). For example, when priority is placed on control based on the ahead-of-vehicle information sensed by the millimeter wave radar rather than control based on the position information from the navigation device (control based on the environmental information), the interruption control permission flag is set, or the interruption permission level is set to a high level. The ahead-of-vehicle information includes not only information of the preceding running vehicle but also information of an intersection or a corner ahead.

Acceleration/deceleration or the driving torque expected by the driver is operated based on the current vehicle state, the driver's manipulation, and the environmental information (S1300). Here, when the driver dislikes the step in gear shift, brake 560 is caused to be responsible for deceleration without shifting down transmission 240 to the lowest gear (first gear) in stopping the vehicle (transmission 240 not responsible for requested deceleration), for example. In addition, when the driver presses down the brake pedal while the lowest speed side gear ratio is set (YES at S1340), the driver feels that the driving torque is large. Accordingly, when such a state is repeated, this situation is learned, and control is exerted such that the gear ratio of transmission 240 is set to a higher-speed side so as to lower the driving torque. Such control corresponds to determination of the driver's intention and calculation of the driver's expected value (S1360).

When braking/driving control is exerted (YES at S1340), distribution determination processing is carried-out (S1500). Here, priority is placed on execution of interruption control corresponding to the most recent vehicle control request, rather than the global vehicle control request by the navigation device or the like. In other words, interruption control is carried out such that the requested driving force is calculated based on the global information by navigation (constant environmental information), setting for placing highest priority on improvement in fuel efficiency in realizing the requested driving force is made, and control for calculating an operated amount of each device is interrupted.

In interruption control, the requested driving force is calculated so as to adapt to the most recent vehicle control request (S1530), priority is determined (S1540), and an operated amount and response of each device is calculated. In other words, selection from devices in the power train system (engine 140, transmission 240) and in the brake system (brake 560) is made so as to predict a future vehicle state and to satisfy a request in a shortest time period with best fuel efficiency, and an operated amount of the device is calculated.

As described above, according to the specific examples set forth above, the millimeter wave radar is used to sense a distance from the preceding vehicle or to operate a relative velocity. If it is determined that the driver requests greater and quicker deceleration using a brake pressing force by the driver as a parameter, great deceleration can be obtained by quicker shift-down of the transmission. This can facilitate tracking of the preceding vehicle, and mitigate burden imposed on the brake. For example, information on surroundings of the vehicle such as red traffic signal at an intersection causing temporary stop of the vehicle or stopping of the preceding vehicle is obtained, so as to exert integrated control different from the conventional example. Conventionally, for example, the gear ratio of the transmission has been determined in accordance with the vehicle speed or deceleration, and the lowest gear ratio (first gear, for example) has been selected when the vehicle is stopped. In the specific example, when an intention of the driver to avoid the step in the torque (acceleration/deceleration) due to sudden deceleration or gear shift can be estimated, the vehicle is stopped at a second gear or a third gear without shifting down the gear ratio to the first gear. Here, distribution control is carried out such that deceleration not satisfied by engine brake of the transmission in spite of the driver's request is compensated for with the brake serving as the brake system. In addition, when the driver presses down the brake in stopping the vehicle by shifting down to the first gear, this means that the driving torque from the first gear of the transmission is too large. In order to attain the driving force requested by the driver, control to shift the gear ratio of the transmission toward a higher-speed side is carried out.

Thus, the vehicle integrated control system of the present embodiment operates as follows: at main control system (1) identified as the driving system control unit, accelerator pedal manipulation that is a request of a driver is sensed, and a control target of the driving system corresponding to the accelerator pedal manipulation is generated using a driving basic driver model, whereby the power train that is a drive actuator is controlled. At main control system (2) identified as the brake system control unit, brake pedal manipulation that is a request of the driver is sensed, and a control target of the brake system corresponding to the brake pedal manipulation is generated using a brake basic driver model, whereby the brake device that is the braking actuator is controlled. At main control system (3) identified as the steering system control unit, steering manipulation that is a request of the driver is sensed, and a control target of the steering system corresponding to the steering manipulation is generated using a steering basic driver model, whereby the steering device that is an actuator is controlled. These control units operate autonomously.

In addition to the driving system control unit, brake system control unit, and steering system control unit operating autonomously, there are further provided an adviser unit, an agent unit, and a supporter unit. The adviser unit generates and provides to respective control units information to be used at respective control units based on environmental information around the vehicle or information related to the driver. The adviser unit processes information representing the degree of risk with respect to operation characteristics of the vehicle based on the frictional resistance of the running road, outer temperature and the like as environmental information around the vehicle, and/or information representing the degree of risk with respect to the manipulation of a driver based on the fatigue level of the driver upon shooting a picture of the driver so as to be shared among respective control units. The agent unit generates and provides to respective control units information to be used at respective control units to cause the vehicle to implement a predetermined behavior. The agent unit generates information to implement an automatic cruise functions for automatic cruising of vehicle. Information to implement the automatic cruise function is output to respective control units. The supporter unit generates and provides to respective control units information to be used at respective control unit based on the current dynamic state of the vehicle. The supporter unit identifies the current dynamic state of the vehicle to generate information required to modify the target value at respective control units.

At respective control units, arbitration processing is conducted as to whether information output from the adviser unit, agent unit and supporter unit is to be reflected in the motion control of the vehicle, and if to be reflected, the degree of reflection thereof. These control unit, adviser unit, agent unit and supporter unit operate autonomously. Eventually at respective control units, the power train, brake device, and steering device are controlled based on the eventual drive target, braking target, and steering target calculated by information input from the adviser unit, agent unit and supporter unit, as well as information communicated among respective control units.

Thus, the driving system control unit corresponding to a “running” operation that is the basic operation of the vehicle, the brake system control unit corresponding to a “stop” operation, and the steering system control unit corresponding to a “turning” operation are provided operable in a manner independent of each other. With respect to these control units, the adviser unit, agent unit and supporter unit are provided, that can generate and output to respective control units information related to the risk and stability with respect to environmental information around the vehicle and information related to the driver, information to implement automatic cruise function for automatic cruising of the vehicle, and information required to modify the target value of respective control units to these control units. Therefore, a vehicle integrated control system that can readily accommodate automatic cruising control of high level can be provided.

According to the specific examples described above, the vehicle integrated control system is used to execute distribution control of the braking/driving torque particularly using the distribution functions of the main control system (accelerator) and the main control system (brake). The braking/driving torque requested by the driver can thus be attained by integrated control.

In the case where the flag from the adviser unit, agent unit and supporter unit is reset with the manipulation of the driver given highest priority, control using a signal from these driving support units will not be conducted.

Although the present invention has been described and illustrated in detail, it is clearly understood that the same is by way of illustration and example only and is not to be taken by way of limitation, the spirit and scope of the present invention being limited only by the terms of the appended claims.

1. A vehicle integrated control system comprising:
a plurality of control units controlling a running state of a vehicle based on a manipulation request; and
a processing unit generating information to be used at said control unit;
providing the generated information to each said control unit ; wherein
said processing unit includes
a determination unit for determining driver's intention to avoid torque fluctuation involved with at least one of sudden deceleration/acceleration and speed change, and a calculation unit for calculating information related to a control target to manipulate an actuator set in correspondence with each said control unit, said control target being in accordance with an expected value of a driver based on determined said driver's intention, based on environmental information around said vehicle and said manipulation request, and calculating information for allotting a driving force and a braking force in said control unit, based on information related to said calculated control target.

2. The vehicle integrated control system according to claim 1, wherein
said calculation unit calculates said information with priority being placed on a time for attaining said control target.

3. The vehicle integrated control system according to claim 1, wherein
said calculation unit calculates said information with priority being placed on drivability.

4. The vehicle integrated control system according to claim 1, wherein
said calculation unit calculates said information with priority being placed on energy efficiency of said vehicle.

5. The vehicle integrated control system according to claim 1, wherein said environmental information represents information on surroundings of the vehicle at present.

6. The vehicle integrated control system according to claim 1, wherein said environmental information represents information on surroundings of the vehicle in future.

7. The vehicle integrated control system according to claim 1, wherein said environmental information represents information on an acceleration/deceleration state of said vehicle.

8. The vehicle integrated control system according to claim 1, wherein said environmental information represents information sensed by a navigation device.

9. The vehicle integrated control system according to claim 1, wherein said environmental information represents information sensed by a radar device.

10. The vehicle integrated control system according to claim 1, wherein
said manipulation request is obtained by sensing an operated amount as to an accelerator manipulation and a brake manipulation by a driver.

11. The vehicle integrated control system according to claim 1, wherein
said manipulation request is obtained by sensing an operated amount as to an accelerator manipulation, a brake manipulation, and a transmission manipulation by a driver.

12. A vehicle integrated control system comprising:
a plurality of control units controlling a running state of a vehicle based on a manipulation request; and
a processing unit generating information to be used at said control unit and providing the generated information to each said control unit; wherein
said processing unit includes
means for determining driver's intention to avoid torque fluctuation involved with at least one of sudden deceleration/acceleration and speed change, and
calculation means for calculating information related to a control target to manipulate an actuator set in correspondence with each said control unit, said control target being in accordance with an expected value of a driver based on determined said driver's intention, based on environmental information around said vehicle and said manipulation request, and calculating information for allotting a driving force and a braking force in said control unit, based on information related to said calculated control target.

13. The vehicle integrated control system according to claim 12, wherein said calculation means includes means for calculating said information with priority being placed on a time for attaining said control target.

14. The vehicle integrated control system according to claim 12, wherein said calculation means includes means for calculating said information with priority being placed on drivability.

15. The vehicle integrated control system according to claim 12, wherein said calculation means includes means for calculating said information with priority being placed on energy efficiency of said vehicle.

16. The vehicle integrated control system according to claim 12, wherein said environmental information represents information on surroundings of the vehicle at present.

17. The vehicle integrated control system according to claim 12, wherein said environmental information represents information on surroundings of the vehicle in future.

18. The vehicle integrated control system according to claim 12, wherein said environmental information represents information on an acceleration/deceleration state of said vehicle.

19. The vehicle integrated control system according to claim 12, wherein said environmental information represents information sensed by a navigation device.

20. The vehicle integrated control system according to claim 12, wherein said environmental information represents information sensed by a radar device.

21. Amended) The vehicle integrated control system according to claim 12, wherein
said manipulation request is obtained by sensing an operated amount as to accelerator manipulation and a brake manipulation by a driver.

22. The vehicle integrated control system according to claim 12, wherein
said manipulation request is obtained by sensing an operated amount as to an accelerator manipulation, a brake manipulation, and a transmission manipulation by a driver.
